(19) United States
(12) Patent Application Publication
(10) Pub. No.: US 2021/0120491 A1
(43) Pub. Date: Apr. 22, 2021

(54) INFORMATION PROCESSING APPARATUS, CONTROL METHOD, AND PROGRAM

(71) Applicant: NEC Corporation, Minato-ku, Tokyo (JP)

(72) Inventor: Ashirwad GUPTA, Tokyo (JP)

(73) Assignee: NEC Corporation, Minato-ku, Tokyo (JP)

(21) Appl. No.: 17/257,683

(22) PCT Filed: Jul. 3, 2018
(86) PCT No.: PCT/JP2018/025267

§ 371 Date: Jan. 4, 2021

(51) Int. Cl. H04W 52/02; H04W 4/029

(52) U.S. Cl. CPC H04W 52/0216; H04W 84/18; H04W 4/029; H04W 52/0229

(57) ABSTRACT

A sensor node (10) and a gateway apparatus (20) perform wireless communication under LPWA protocol. The sensor node (10) may move while communicating with the gateway apparatus (20). An information processing apparatus (2000) predicts a new location of the sensor node (10) at which the sensor node (10) is predicted to be located at the time of the subsequent data transmission. Then, the information processing apparatus (2000) predicts optimal transmission settings of the sensor node (10) for its subsequent communications with the gateway apparatus (20), using the predicted new location of the sensor node (10). The predicted optimal transmission settings is output from the information processing apparatus (2000) so that the sensor node (10) is able to use the predicted optimal transmission settings for the subsequent communications.

### TECHNICAL FIELD

Embodiments of the invention generally relate to the field of Low Power Wide Area (LPWA) communication.

### BACKGROUND ART

Low Power Wide Area (LPWA) communication has emerged as important enabling technology for connecting ubiquitous sensors in IoT for small data transfer for wide areas at low data rate. LPWA network is a type of wireless telecommunication wide area network designed to allow long range communications at a low bit rate among sensors operated on a battery and so on.

Examples of literatures relating to LPWA are PL1 and NPL1. PL1 discloses a radio device that provides multiple radios, and one of which is LoRa radio. LoRa is one of types of LPWA communication protocols.

NPL1 discloses methodology named Adaptive data rate (ADR) for a LoRa node staying at a fixed location (static node). ADR refers to adaptively use the optimal settings for LoRa transmission by utilizing feedback mechanism based on past communications.

### CITATION LIST

### Patent Literature

[PL1] US Patent Application Publication No. US2017/0181033

### Non-Patent Literature

[NPL1] V. Hauser and T. Hegr, “Proposal of Adaptive Data Rate Algorithm for LoRaWAN-Based Infrastructure,” Proceedings of 5th International Conference on Future Internet of Things and Cloud (FiCloud), IEEE, pp. 85-90, Aug. 21, 2017.

### SUMMARY OF INVENTION

### Technical Problem

It is possible that a sensor node is attached to moving object such as a car or a bicycle, and therefore the location of the sensor node may change. However, NPL1 does not take moving nodes into account, and ADR mechanism disclosed by NPL1 can be applied only to static nodes. PL1 also does not mention about adaptive transmission settings of moving nodes performing LPWA communication.

An objective of the present invention is to provide a technique of adaptively configuring transmission settings of moving nodes performing LPWA communication.

### Solution to Problem

There is provided an information processing apparatus comprising: 1) a first prediction unit predicting a new location of a sensor node that moves and transmits data under Low Power Wide Area (LPWA) protocol; 2) a second prediction unit predicting an optimal transmission settings of the sensor node using the predicted new location, the optimal transmission settings being used by the sensor node for subsequent data transmission under the LPWA protocol; and 3) an output unit outputting the optimal transmission settings.

There is provided a control method performed by a computer. The control method comprises: 1) predicting a new location of a sensor node that moves and transmits data under Low Power Wide Area (LPWA) protocol; 2) predicting an optimal transmission settings of the sensor node using the predicted new location, the optimal transmission settings being used by the sensor node for subsequent data transmission under the LPWA protocol; and 3) outputting the optimal transmission settings.

### Advantageous Effects of Invention

In accordance with the present invention, it is provided a technique of adaptively configuring transmission settings of moving nodes performing LPWA communication.

### BRIEF DESCRIPTION OF DRAWINGS

Aforementioned objects, procedure and technique for behavior modeling will be made comprehensible via selected example embodiments, described below, and the aided drawings.

FIG. 1 illustrates an overview of operations of an information processing apparatus of Example Embodiment 1.

FIG. 2 is a block diagram illustrating a function-based configuration of the information processing apparatus of Example Embodiment 1.

FIG. 3 is a block diagram illustrating an example of hardware configuration of a computer realizing the information processing apparatus of Example Embodiment 1.

FIG. 4 is a flowchart that illustrates the process sequence performed by the information processing apparatus of Example Embodiment 1.

FIG. 5 illustrates an example of the delivery schedule.

FIG. 6 illustrates the communication history database in a table format.

FIG. 7 illustrates a use case of the information processing apparatus 2000.

FIG. 8 illustrates an overview of operations of the information processing apparatus 2000 of Example Embodiment 2.

FIG. 9 is a block diagram illustrating a function-based configuration of the information processing apparatus of Example Embodiment 2.

FIG. 10 is a flowchart that illustrates the process sequence performed by the information processing apparatus of Example Embodiment 2.

### DESCRIPTION OF EMBODIMENTS

Hereinafter, example embodiments of the present invention will be described with reference to the accompanying drawings. In all the drawings, like elements are referenced by like reference numerals and the descriptions thereof will not be repeated.

### Example Embodiment 1

### <Overview>

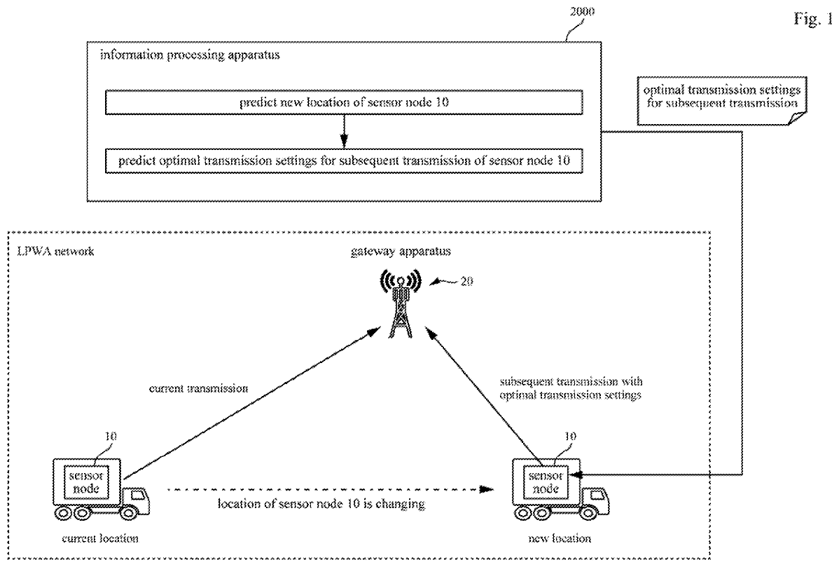

FIG. 1 illustrates an overview of operations of an information processing apparatus 2000 of Example Embodiment 1. The information processing apparatus 2000 handles a sensor node 10 and a gateway apparatus 20. The information processing apparatus 2000 may be implemented in the gateway apparatus 20, or in a central server connected with the gateway apparatus 2000 through a backhaul network.

The sensor node 10 and the gateway apparatus 20 perform wireless communication under LPWA protocol. LoRa (Long-Range) is one of LPWA protocols applied to the communication between the sensor node 10 and the gateway apparatus 20. Note that, although this specification mainly describes LoRa as an example of LPWA protocol applied to LPWA communication between the sensor node 10 and the gateway apparatus 20, applicable LPWA protocol is not limited to LoRa.

The sensor node 10 may moves (i.e. change its location) while communicating with the gateway apparatus 20. For example, the sensor node 10 may be attached to or installed in a moving object, such as a car or a bicycle used for delivery.

The sensor node 10 performs the communication under some transmission settings. For example, if the sensor node performs LoRa communication, its transmission settings include parameters such as Spreading Factor (SF), Transmitting Power (Pt), Code rate (CR), bandwidth, and so on. It is preferable to choose the transmission settings in order to make it optimal the communication between the sensor node 10 and the gateway apparatus 20. The criteria of “optimal” may be, for example, battery consumption of the sensor node 10.

In the case that the sensor node 10 moves, optimal transmission settings of the sensor node 10 may change along with the location of the sensor node 10 due to various factors like weather, distance between node and gateway, etc. Therefore, the information processing apparatus 2000 repeatedly predicts optimal transmission settings for subsequent communications of the sensor node 10 with the gateway apparatus 20.

Specifically, the information processing apparatus 2000 predicts a new location of the sensor node 10 at which the sensor node 10 is predicted to be located at the time of the subsequent data transmission. For example, this predication may be performed based on the current location and velocity of the sensor node 10.

Then, the information processing apparatus 2000 predicts optimal transmission settings of the sensor node 10 for its subsequent communications with the gateway apparatus 20, using the predicted new location of the sensor node 10. The predicted optimal transmission settings is output from the information processing apparatus 2000 so that the sensor node 10 is able to use the predicted optimal transmission settings for the subsequent communications.

### Advantageous Effect

In LPWA network, decision of optimal transmission settings for moving sensor nodes has a lot of difficulties. First of all, the signal quality of LPWA communication depends on environments around the sensor node, such as distance from the gateway, line of sight, and etc. Therefore, it is required for moving sensor nodes to repeatedly adjust its transmission settings taking into consideration the environments around it at the timing of data transmission. However, sensor nodes, such as IoT nodes, have generally too low computational power to make smart decisions, and it is difficult for the sensor node to decide optimal transmission settings by itself.

One possible way of determining optimal transmission settings is that the sensor node performs test communication (hand-shake) with the gateway before transmitting data to the central server. However, with LPWA protocols, such solution doesn't work due to many factors. At first, it takes up battery to send test messages. Second, due to low data rate, test messages take time, during which the vehicle to which the sensor node is attached already changes its location. Third, for protocols using unlicensed spectrum, only limited message transfers are possible because of duty cycle restrictions, thus test messages leads to reduction in important message transfer.

For moving nodes using LoRa till now, naive approach has been taken which is to communicate with high battery consumption parameters (e.g. highest power transmission, high SF). But this creates a severe battery consumption problem as a naive method can consume as much as 100 times more battery than optimal configuration setting. Thus, smarter way of choosing configuration setting for moving sensor nodes is very important task to be solved for utilizing LoRa and other LPWA networks for efficient battery usage.

According to the information processing apparatus 2000 of Example Embodiment 1, where the sensor node 10 is located at the time of its subsequent transmission is predicted as a new location thereof, and the optimal transmission settings of the sensor node 10 for LPWA communication with the gateway apparatus 20 is determined based on the predicted new location. Thus, it is able to achieve adaptive configuration of the transmission settings for moving LPWA nodes.

One of criteria of determining the transmission settings of the sensor node 10 may be battery consumption of the sensor node 10. Generally, the battery of a node is consumed in maintaining high signal quality between the node and the gateway while performing wireless communication through a gateway since signal quality greater than a certain threshold level is required between the node and the gateway for successful communication. Therefore, it is able to reduce the battery consumption of the sensor node 10 by achieving the signal quality high enough for communication. The information processing apparatus 2000 can suppress the battery consumption of the sensor node 10 even if the sensor node 10 moves, since it predicts optimal transmission settings of the sensor node 10 taking the change of the location of the sensor node 10 into consideration.

Here, the advantageous effect of this example embodiment is described in more detail focusing LoRa communication. Out of various LPWA communications, LoRa is being considered as the most promising one. As name suggests, LoRa can provide communication over long range, up to 10 km, for very less battery consumption, based on the environment and setting used. This provides an advantage of having wider coverage area with less number of base stations and maintaining simple star topology network, which means direct connection of devices a.k.a. nodes to the gateways. This makes the system easy to deploy and prevent it from complicated routing protocol. Besides, LoRa operates in unlicensed spectrum, which allows private players to set up their private network without paying expensive spectrum usage fees.

However, LoRa comes with certain challenges as well. LoRa has very small data rate, ranging from 0.3 kbps to 50 kbps. This limits the amount of data to be exchanged. Also, as LoRa works in unlicensed spectrum, it has increased possibility of collisions during message exchange. Due to this, there is duty cycle restrictions which allows each node to transmit only certain amount of time ranging from 0.1 to 10%, based on region and utility. This enables more devices to be connected without collisions. But due to it, each node can only send a few messages a day to the gateways. These properties of LoRa give unique combination of challenges to tackle which are different than other wireless communications.

In LoRa systems, battery of the nodes plays an important role as they form the major Operational expenditure (OPEX) and capital expenditure (CAPEX). Thus, optimized use of battery is required. As mentioned above, LoRa has several parameters such as Spreading Factor, Bandwidth, Code rate, Transmitted power, etc. which can be set independently but it affects the range of communication, data rate and also battery consumption. Thus, these parameters have to be selected intelligently to enable communication without draining unnecessary resources.

To optimize battery consumption, LoRa system uses methodology named Adaptive data rate (ADR) for static nodes. ADR refers to adaptively use the optimal settings for LoRa transmission by utilizing feedback mechanism based on past communications. Thus, ADR is a way to optimize these parameters for lowest battery consumption without degrading communication quality between nodes and gateways. Based on the feedback received, the configuration setting can converge to optimal setting step by step.

As mentioned above, NPL 1 discloses ADR for static nodes, but does not mention about moving nodes. On the other hand, by applying the information processing apparatus 2000 of the present invention to LoRa communication, it is able to predict optimal transmission settings of node even for moving nodes in terms of, for example, battery consumption of nodes. Thus, it is able to achieve more efficient use of LoRa nodes.

In the following descriptions, the detail of the information processing apparatus 2000 of the present Example embodiment will be described.

### <Example of Function-Based Configuration>

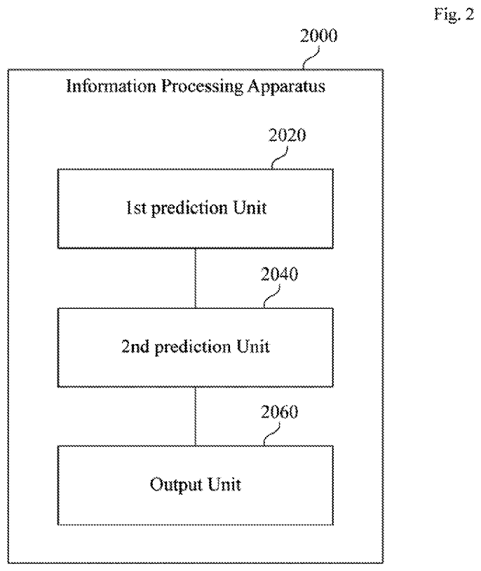

FIG. 2 is a block diagram illustrating a function-based configuration of the information processing apparatus 2000 of Example Embodiment 1. The information processing apparatus 2000 comprises a first prediction unit 2020, a second prediction unit 2040, and an output unit 2060. The first prediction unit 2020 predicts a new location of the sensor node 10. The second prediction unit 2040 predicts optimal transmission settings of the sensor node 10 for its subsequent communications using the predicted new location of the sensor node 10. The output unit 2060 outputs the predicted optimal transmission settings.

### <Example of Hardware Configuration>

Each functional unit included in the information processing apparatus 2000 may be implemented with at least one hardware component, and each hardware component may realize one or more of the functional units. In some embodiments, each functional unit may be implemented with at least one software component. In some embodiments, each functional unit may be implemented with a combination of hardware components and software components.

The information processing apparatus 2000 may be implemented with a special purpose computer manufactured for implementing the information processing apparatus 2000, or may be implemented with a commodity computer like a personal computer (PC), a server machine, or a mobile device.

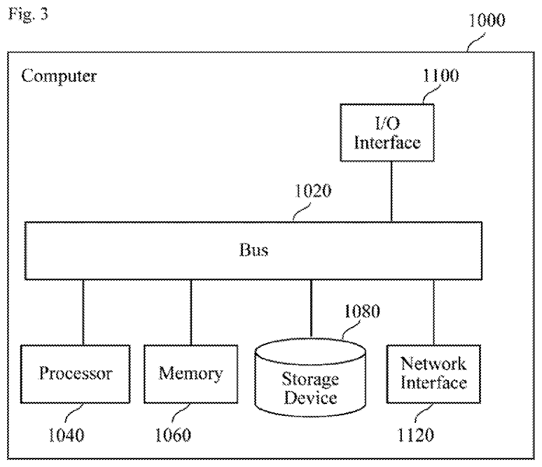

FIG. 3 is a block diagram illustrating an example of hardware configuration of a computer 1000 realizing the information processing apparatus 2000 of Example Embodiment 1. In FIG. 3, the computer 1000 includes a bus 1020, a processor 1040, a memory 1060, a storage device 1080, an input-output (I/O) interface 1100, and a network interface 1120.

The bus 1020 is a data transmission channel in order for the processor 1040, the memory 1060 and the storage device 1080 to mutually transmit and receive data. The processor 1040 is a processor such as CPU (Central Processing Unit), GPU (Graphics Processing Unit), or FPGA (Field-Programmable Gate Array). The memory 1060 is a primary storage device such as RAM (Random Access Memory). The storage medium 1080 is a secondary storage device such as hard disk drive, SSD (Solid State Drive), or ROM (Read Only Memory).

The I/O interface is an interface between the computer 1000 and peripheral devices, such as keyboard, mouse, or display device. The network interface is an interface between the computer 1000 and a communication line through which the computer 1000 communicates with another computer.

The storage device 1080 may store program modules, each of which is an implementation of a functional unit of the information processing apparatus 2000 (See FIG. 2). The CPU 1040 executes each program module, and thereby realizing each functional unit of the information processing apparatus 2000.

### <Flow of Process>

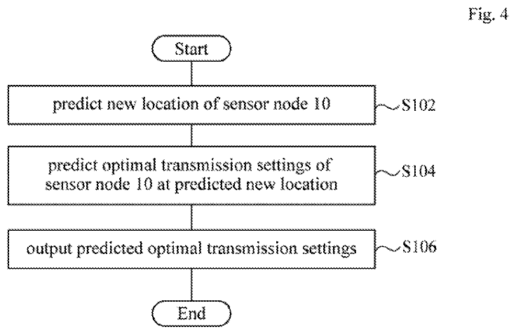

FIG. 4 is a flowchart that illustrates the process sequence performed by the information processing apparatus 2000 of Example Embodiment 1. The first prediction unit 2020 predicts a new location of the sensor node 10 at which the sensor node 10 is predicted to be located at the time of a subsequent transmission (S102). The second prediction unit 2040 predicts optimal transmission settings of the sensor node 10 (S104). The output unit 2060 outputs the predicted optimal transmission settings (S106).

### <As to Sensor Node 10>

The sensor node 10 may be any computer including a sensor and a mechanism for performing LPWA communication with the gateway apparatus 20. Note that, it is able to install any one of various existing mechanisms for performing LPWA communication in the sensor node 10.

### <As to Gateway Apparatus 20>

The gateway apparatus 20 may be any computer that functions as a gateway between wireless communication network to which the sensor node 10 is connected and a backhaul network. The sensor node 10 may communicate with a computer in the backhaul network. For example, the sensor node 10 transmits the results of its sensing to a central server in the backhaul network, which gathers the result of sensing from a plurality of sensor nodes and analyzes those results. The information processing apparatus 2000 may be implemented as the central server in the backhaul network, and communicate with the sensor node 10 through the gateway apparatus 20.

Note that, there are multiple gateway apparatuses 20, and the sensor node 10 changes the gateway apparatus 20 with which the sensor node 10 communicates based on the signal quality.

### <Prediction of New Location of Sensor Node 10: S102>

The first prediction unit 2020 predicts a new location of the sensor node 10 at which the sensor node 10 is predicted to be located at the time of a subsequent transmission (S104). The time of the subsequent transmission (i.e. when the sensor node 10 transmits data) may be determined based on various criteria. For example, the time of the subsequent transmission may be determined as the latest time of transmission plus the pre-determined length of time (10 secs or something). In this case, the sensor node 10 periodically transmits data at fixed intervals. Note that, the subsequent transmission is not limited to the next transmission. For example, the subsequent transmission may be n-th next transmission, where n is the pre-determined integer value.

There may be various ways to predict the new location of the sensor node 10. For example, the first prediction unit 2020 acquires the current location of the sensor node 10 and the velocity of the movement of the sensor node 10 (moving speed and moving direction of the sensor node 10). Based on the acquired speed of the movement of the sensor node 10, the first prediction unit 2020 computes the travel distance of the sensor node 10. Then, the first prediction unit 2020 computes the location moved from the current location by the computed travel distance in the acquired moving direction, as the new location of the sensor node 10.

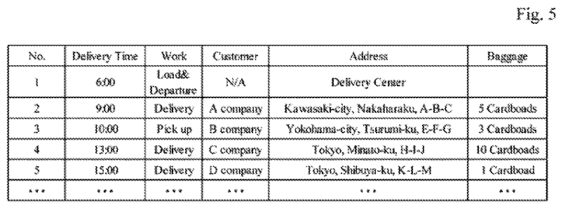

In another example, the first prediction unit 2020 may predict the new location of the sensor node 10 using contextual information related with the movement of the sensor node 10 such as source, destination, current path, live traffic information, path type, delivery schedule etc. For example, a delivery vehicle will be having a delivery schedule that includes destination and time of delivery. FIG. 5 illustrates an example of the delivery schedule. The delivery schedule in FIG. 5 shows: number allocated to a schedule (No.); time at which the work is scheduled (Delivery Time); the work to do (Work); name of customer (Customer); address of the customer (Address); and baggage that is to be delivered or picked up (Baggage).

Such contextual information can be utilized by the first prediction unit 2020 to gather further real time information such as the expected time of arrival, traffic signals, traffic condition, average speed of other vehicles and path of movement using internet and live Maps (e.g. Google Maps or Yahoo Maps). Using the real time information with contextual data, different predictive techniques or grey modeling methods can be used to predict the new location of the sensor node 10 at which the sensor node 10 is predicted to be located at the time of the subsequent communication.

In order to perform the above-mentioned prediction, the first prediction unit 2020 acquires necessary data. When using the current location of the sensor node 10, the first prediction unit 2020 may acquire location data indicating the current location of the sensor node 10. This location data may be generated with a location sensor such as Global Positioning System (GPS) sensor included in the sensor node 10 or in the moving object to which the sensor node 10 attached. The location data may be transmitted by the sensor node 10 with the sensed data.

In terms of the current velocity of the sensor node 10, the first prediction unit 2020 may acquire acceleration data indicating accelerations of the sensor node 10, and thereby computing the current velocity of the sensor node 10. The acceleration may be measured by the acceleration sensor that is included in the sensor node 10 or in the moving object to which the sensor node 10 is attached. The acceleration data may be obtained in a similar manner to the location data.

As to contextual data, a way of acquiring it depends on a type of contextual data to be acquired. There are various well-known ways to acquire contextual data, and the first prediction unit 2020 can use one of such ways.

Note that, the location of the sensor node 10 is not necessarily tracked with a location sensor, and it may be calculated without sensed location data. For example, the current location of the sensor node 10 may be calculated based on server localization techniques using difference in signal quality between the sensor node 10 and multiple gateway apparatuses. In this case, there are multiple gateway apparatuses each of which receives signal from the sensor node 10. Quality of signal received by the gateway apparatus is based on attenuation caused by wireless channel depending on the distance between the gateway apparatus and the source of the signal (i.e. sensor node 10).

Thus, from at least three gateway apparatus each of which communicates with the sensor node 10, the first prediction unit 2020 may acquire a signal quality indicator, such as Received Signal Strength Indicator (RSSI) and Signal-to-Noise Ratio (SNR), that indicates the quality of signal from the sensor node 10. Based on the acquired signal quality indicators, the first prediction unit 2020 computes the distance between each gateway apparatus and the sensor node 10, and determines the current location of the sensor node 10 based on the computed distances. Note that, not only gateway apparatus but also other devices communicating with the sensor node 10 can provide the signal quality indicator indicating the quality of signal from the sensor node 10.

In addition to the current location of the sensor node 10, the current velocity of the sensor node 10 may be determined without tracking the sensor node 10. For example, the current velocity of the sensor node 10 may be estimated using various methods such as distance travelled since previous transmission, surrounding environment knowledge such as traffic condition on the roads, average velocity of other vehicles, time taken to travel the given distance etc., which can be gathered from the internet.

### <Prediction of Optimal Transmission Settings: S104>

The second prediction unit 2040 predicts optimal transmission settings of the sensor node 10 for the subsequent communications between the sensor node 10 and the gateway apparatus 20 (S104). For this prediction, a prediction model is constructed in advance through techniques such as statistical modeling or supervised learning. The second prediction unit 2040 feeds necessary information (at least, the new location of the sensor node 10) to the prediction model, and thereby obtaining from the prediction model the optimal transmission settings of the sensor node 10 for the subsequent transmission at the predicted the new location. At least, the optimal transmission settings are predicted so that the signal quality of LPWA communication between the sensor node 10 and the gateway apparatus 20 under the predicted transmission settings becomes higher than a pre-determined threshold. The pre-determined threshold represents the signal intensity required by the receiver (i.e. gateway device 20) for good LPWA communication city with the sensor node 10. In addition, the signal intensity required by the receiver depends on characteristics of the receiver, such as hardware configuration thereof.

The prediction model can be constructed using database of history of communications performed by any sensor node 10. Hereinafter, the database of history of communications is called communication history database. The communication history database may associate: distance between the sensor node 10 and the gateway apparatus 20; transmission settings of the sensor node 10; and a signal quality indicator of the communication between the sensor node 10 and the gateway apparatus 20. The distance between the sensor node 10 and the gateway apparatus 20 is a factor of affecting signal quality of wireless communication between the sensor node 10 and the gateway apparatus 20. The distance may be calculated based on the location of the sensor node 10 and the location of the gateway apparatus 20. Using the communication history database, it is possible to determine transmission settings associated with the best signal quality indicator as the optimal transmission settings, for each distance between the sensor node 10 and the gateway apparatus 20.

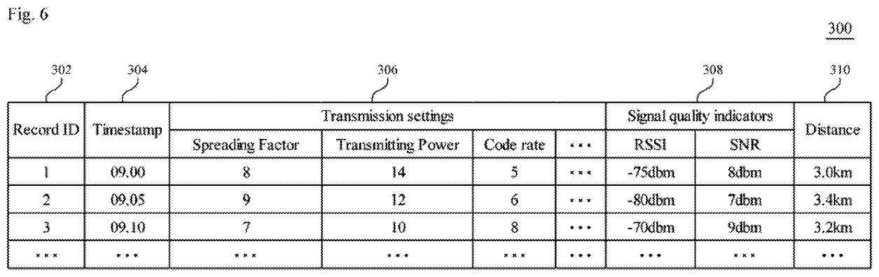

FIG. 6 illustrates the communication history database in a table format. The table depicted by FIG. 6 is called Table 300. Note that, FIG. 6 assumes that LoRa protocol is used. Table 300 includes columns named Record ID 302, Timestamp 304, Transmission settings 306, and Signal quality indicators 308, and Distance 310. Transmission settings 306 includes Spreading Factor, Transmitting Power, Code rate and etc., which are transmission settings of LoRa nodes. Signal quality indicators 308 includes RSSI and SNR, which are examples of indicators of the signal quality. Distance 310 represents the distance between the sensor node 10 and the gateway apparatus 20, which is a representative factor affecting the signal quality of LPWA communication between the sensor node 10 and the gateway apparatus 20.

In addition to the distance between the sensor node 10 and the gateway apparatus 20, the communication history database (e.g. Table 300) may include other factors of affecting the signal quality of LPWA communication between the sensor node 10 and the gateway apparatus 20. Examples of such factors are environment parameters including temperature, humidity, type of weather (e.g. sunny, cloudy, or rainy), and so on. When using the environment parameters for the prediction, the second prediction unit 2040 acquires those parameters for the new location of the sensor node 10. Note that, environment parameters are generally open data available on the Internet, and therefore the second prediction unit 2040 may acquire those data from the Internet. Other examples of factors affecting the signal quality of LPWA communication are line of sight and speed of movement of the sensor node 10.

Note that, a prediction model may be constructed based on the communication history database by using various well-known predictive machine learning algorithms such as support vector regression, random forest, and etc. Specifically, the prediction model is learned with supervised machine learning using the communication history database as training data.

### <How to Construct Communication History Database>

It is required to construct the communication history database for the above-mentioned prediction of the optimal transmission settings. In order to construct the communication history database, the history of communications performed between sensor nodes 10 and the gateway apparatus 20 is accumulated. Specifically, the signal quality indicator of wireless communication between the sensor node 10 and the gateway apparatus 20 and the information to be associated with the signal quality indicator (i.e. distance and environment parameters) are recorded when the communication is performed.

For example, the information processing apparatus 2000 gathers information to be recorded in the communication history database at each time of predicting the optimal transmission settings of the sensor node 10, associates the gathered information with each other so as to form a record of the communication history database, and adds the associated data (i.e. generated record) into the communication history database.

The signal quality indicator of communication between the sensor node 10 and the gateway apparatus 20 may be obtained from the gateway apparatus 20. For example, when the information apparatus 2000 is implemented as the central server in the backhaul network, the gateway apparatus 20 receives the sensed data from the sensor node 10, transmits the received data with the signal quality indicator to the information processing apparatus 2000. As a result, the information processing apparatus 2000 can obtain the sensed data and the signal quality indicator.

Some environment parameters, such as temperature or humidity, may be measured by sensors included in the sensor node 10 or in the moving objects to which the sensor node 10. As mentioned above, such sensed data may be transmitted to the gateway apparatus 20, and the information processing apparatus 2000 can obtain those data from the gateway apparatus 20.

Other environment parameters, such as a type of weather (rainfall, cloudy and so on), may be open data, and the information processing apparatus 2000 can obtain those data from the Internet.

### <Output of Result of Prediction: S106>

The output unit 2060 outputs the predicted optimal transmission settings (S106). It is necessary to notify the sensor node 10 of the predicted optimal transmission settings so that the sensor node 10 adopts it. For example, the output unit 2060 transmits the predicted optimal transmission settings to the gateway apparatus 20, and then the gateway apparatus 20 transmits the predicted optimal transmission settings to the sensor node 10 through the LPWA communication.

### <Use Case: Logistics>

One of attractive use cases of the information processing apparatus 2000 is a scene of logistics. A logistics company wants to monitor every minute its container's condition including temperature, humidity, velocity, and location. In order to do so, the container is equipped with all relevant sensors including temperature sensor, humidity sensor, accelerometer, and GPS. As data size is small and the system is delay tolerant, LoRa system serves a perfect use case for it. Compared to having a mobile subscription with monthly expenditure, LoRa provides it for free. Thus, such vehicle tracking can be done with lesser battery consumption, and therefore OPEX for changing batteries can become significantly lower.

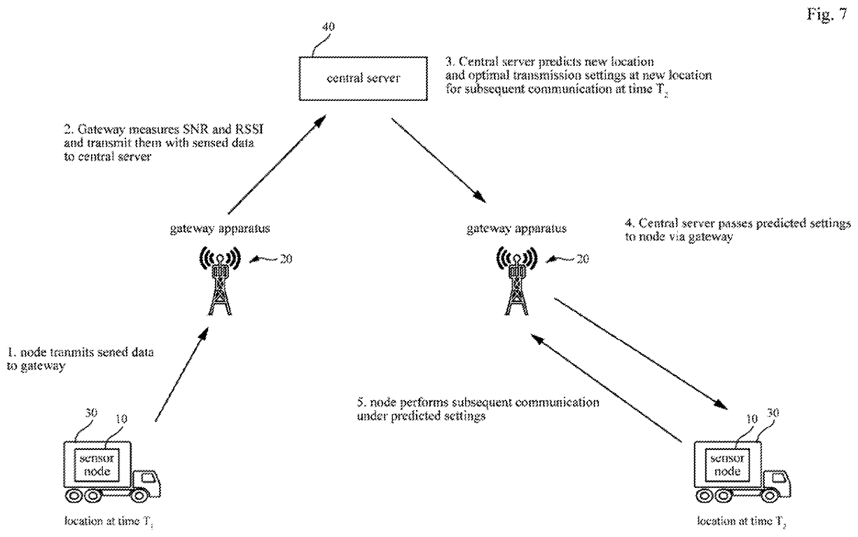

FIG. 7 illustrates a use case of the information processing apparatus 2000. In FIG. 7, a vehicle 30 delivers logistics containers. The sensor node 10 is included in the vehicle 30, and required to transmit the status of the logistics containers to the central server 40. In this use case, the information processing apparatus 2000 is implemented as the central server 40. The central server 40 is managed by a logistics company.

The sensor node 10 measures temperature, humidity, location, and accelerometer, and transmits these sensed data to the central server 40 via the gateway apparatus 20: the network between the sensor node 10 and the gateway apparatus 20 is LoRa network, whereas that between the gateway apparatus 20 and the central server 40 is the backhaul network. When receiving the sensed data from the sensor node 10, the gateway apparatus 20 measures the SNR and RSSI of the signal from the sensor node 10, and transmits them to the central server 40 along with the sensed data received from the sensor node 10.

The central server 40 records the received data into the communication history database. Then, the central server 40 (i.e. the information processing apparatus 2000) performs processes for predicting optimal transmission settings: predicting the new location of the sensor node 10 and predicting the optimal transmission settings of the sensor node 10 at the predicted new location.

For predicting the new location of the server node 10, the central server 40 utilizes contextual information such as delivery schedule, destination, etc. and real time information near the current location such as the traffic information, road type (ex. highway, unpaved road, single-lane), traffic signals, average speed of other vehicles in the route, etc. from the internet. After predicting the new location, the central server 40 obtains the current weather conditions for the predicted new location to observe the wireless conditions in the area such as temperature, rainfall, and other weather conditions. With the new acquired information, the central server 40 predicts optimal settings for LoRa communication using supervised machine learning algorithm such as support vector machines, linear regression, random forest, etc. on historical data available from communication history database, or by simulating wireless channel behavior models.

The central server 40 transmits the predicted optimal transmission settings to the sensor node 10 via the gateway apparatus 20. The sensor node 10 configures itself with the received optimal transmission settings before the subsequent transmission, and then transmits the above-mentioned data to the central server 40.

### Second Example Embodiment

### <Overview>

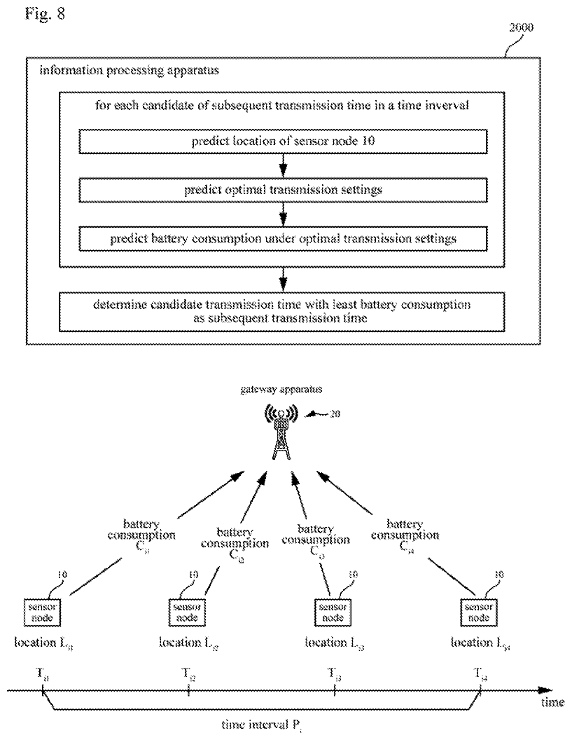

FIG. 8 illustrates an overview of operations of the information processing apparatus 2000 of Example Embodiment 2. It is assumed that the sensor node 10 is required to transmit data through the gateway apparatus 20 once anytime in a given length of time interval (e.g. 60 seconds). In other words, it is not fixedly determined when the sensor node 10 transmits data. This means that there is a room for achieving more optimal data transmission of the sensor node 10 by controlling the timing of data transmission.

Therefore, the information processing apparatus 2000 of Example Embodiment 2 determines for the sensor node 10 when to transmit data through the gateway apparatus 20 taking the signal quality between the sensor node 10 and the gateway apparatus 20 into consideration. Specifically, the information processing apparatus 2000 of Example Embodiment 2 predicts optimal transmission settings for each of multiple candidates of transmission time (multiple candidates of location) in a subsequent time interval, and determines the candidate corresponding to the location which requires least battery for transmitting a given data best signal quality as the transmission time for the subsequent time interval.

In the example depicted by FIG. 8, the sensor node 10 needs to transmit data through the gateway apparatus 20 to the central server in the backhaul network one anytime in a time interval. The candidates of the transmission time in a subsequent time interval Pi are Ti1, Ti2, Ti3, and Ti4. For each of 4 candidates of transmission time, the information apparatus 2000 predicts optimal transmission settings and the signal quality that is achieved under the predicted optimal transmission settings. In FIG. 8, the battery consumption calculated for 4 candidates are Ci1, Ci2, Ci3, and Ci4 respectively. Suppose that Ci3 indicates the least battery consumption for the transmission. In this case, the information processing apparatus 2000 determines, for the subsequent time interval Ti, that Ti3 is the best time for data transmission by the sensor node 10 in terms of the battery consumption of the sensor node 10. Then, the sensor node 10 transmits the data using LPWA protocol at Ti3.

### <Advantageous Effect>

In accordance with the information processing apparatus 2000 of Example Embodiment 2, optimal transmission settings are predicted for multiple candidates of transmission times in each time interval instead of predicting optimal transmission settings for a fixed location, and the best transmission time is determined based on the battery consumption for the data transmission through the LPWA network for each time interval. By doing so, it is able to choose the timing of transmission so that data transmission is performed with least battery consumption, and therefore the battery consumption of LPWA node can be reduced more than the case in which the timing of data transmission is fixed.

In the following descriptions, the detail of the information processing apparatus 2000 of the present Example embodiment will be described.

### <Example of Function-Based Configuration>

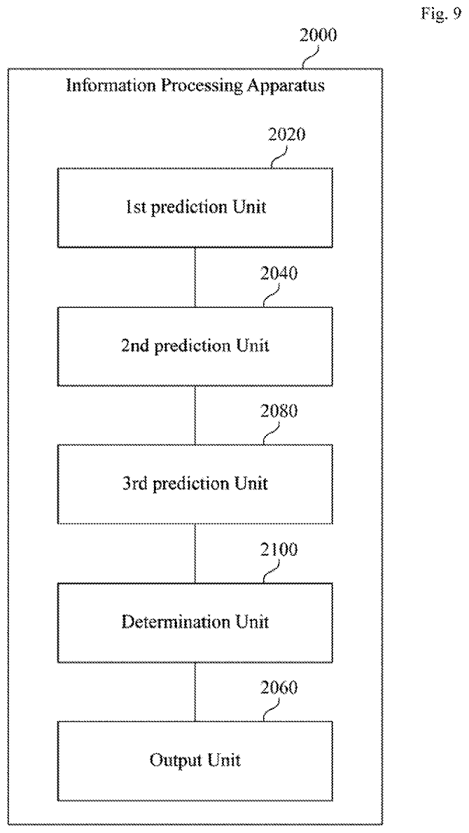

FIG. 9 is a block diagram illustrating a function-based configuration of the information processing apparatus 2000 of Example Embodiment 2. In addition to the function blocks depicted by FIG. 2, the information processing apparatus 2000 of Example Embodiment 2 further comprises a third prediction unit 2080 and a determination unit 2100.

For each candidate transmission time in a time interval, the first prediction unit 2020 predicts a location of the sensor node 10 at the candidate transmission time, the second prediction unit 2040 predicts optimal transmission settings of the sensor node 10 at the predicted location, and the third prediction unit 2080 predicts battery consumption of the sensor node 10 for LPWA communication with the gateway apparatus 20 under the predicted optimal transmission settings. The determination unit 2100 determines, as the subsequent transmission time in the subsequent time interval, the candidate transmission time corresponding to the least battery consumption among predicted battery consumptions for each candidate transmission time. The output unit 2060 outputs the determined transmission time and the optimal transmission settings predicted for the determined transmission time. Note that, if the battery consumption of the sensor node 10 is calculated when the second prediction unit 2040 predicts the optimal transmission settings, the third prediction unit 2080 just outputs the battery consumption calculated by the second prediction unit 2060.

### <Example of Hardware Configuration>

Similar to the information processing apparatus 2000 of Example Embodiment 1, that of Example Embodiment 2 may be implemented with the computer 1000 depicted by FIG. 3. However, the storage device 1080 of Example Embodiment 2 further stores program modules that implement the additional functions of the information processing apparatus 2000 of Example Embodiment 2.

### <Flow of Process>

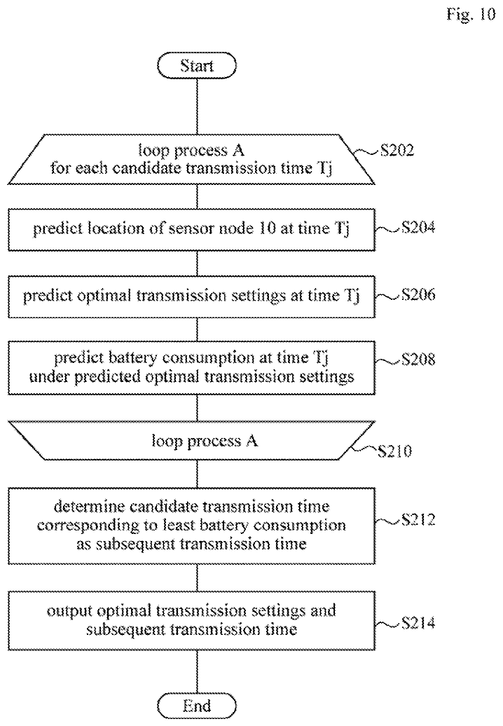

FIG. 10 is a flowchart that illustrates the process sequence performed by the information processing apparatus 2000 of Example Embodiment 2. Step S202 to S210 forms loop process A performed for each candidate of transmission time. In S202, the information processing apparatus 2000 determines whether there exist candidate transmission times for which the loop process A is not performed yet. If exists, the information processing apparatus 2000 selects one of such candidate transmission times as a target (called candidate time Tj) for the loop process A, and the process of FIG. 10 proceeds to S204. If not exists, the process of FIG. 10 proceeds to S212.

The first prediction unit 2020 predicts the location of the sensor node 10 at the time Tj (S204). The second prediction unit 2040 predicts the optimal transmission settings for the sensor node 10 at the time Tj (S206). The third prediction unit 2080 predicts battery consumption of the sensor node 10 for LPWA communication with the gateway apparatus 20, which LPWA communication is assumed to be performed at time Tj under the optimal transmission settings predicted for time Tj (S208).

After finishing the loop process A for every candidate of transmission time, the determination unit 2100 determines, as the subsequent transmission time of the sensor node 10, the candidate transmission time corresponding to the location which requires the least battery consumption among the predicted battery consumptions (S212). The output unit 2060 outputs the determined subsequent transmission time and the optimal transmission settings corresponding to the determined subsequent transmission time (S214). Based on this result, the sensor node 10 transmits data at the output subsequent transmission time with the output optimal transmission settings.

### <As to Candidate Transmission Time>

The determination unit 2100 determines the best time for transmission by the sensor node 10, among a plurality of candidates of transmission times. The candidates of the transmission time can be determined by various ways. For example, the information processing apparatus 2000 determines the candidates by dividing a subsequent time interval by a pre-determined number.

### <Prediction of Battery Consumption: S208>

The third prediction unit 2080 predicts battery consumption of the sensor node 10 for the LPWA communication with the gateway apparatus 20 for each candidate transmission time (S208). This LPWA communication is assumed to be performed at the candidate transmission time under the optimal transmission settings predicted for this candidate transmission time.

The battery consumption of the sensor node 10 for data transmission is governed by the energy used to drive a transmitter in the sensor node 10 to output the signal, and the amount of used energy (i.e. battery consumption) depends on the size of data to be transmitted, transmission settings, and the specification of the transmitter. The third prediction unit 2080 may predict the battery consumption of the sensor node 10 at a candidate transmission time based on the size of data to be transmitted, the transmission settings predicted for the candidate transmission time, and the specification of the sensor node 10.

For example, the battery consumption of the sensor node 10 using LoRa protocol may be calculated using the following equation (1) and (2):

$$\begin{matrix}Equation 1 & \\ {R}_{b} = SF * \frac{[ \frac{4}{4 + CR} ]}{\frac{{2}^{SF}}{BW}} * 1000 & ( 1 ) \\ Battery Consumpton = \frac{S}{Rb} * {V}_{b} * C & ( 2 )\end{matrix}$$

In Equation (1), SF, CR, BW, and Rb represent Spreading Factor, Code Rate, Bandwidth in KHz, and Data rate or Bit Rate in bps, respectively. In Equation (2), S, Vb, and C represent data packet size to be transmitted, the voltage of the battery, and the current drawn from the battery respectively. Note that, Vb and C can be found from LoRa chip specification sheet.

As described above, although the example embodiments of the present invention have been set forth with reference to the accompanying drawings, these example embodiments are merely illustrative of the present invention, and a combination of the above example embodiments and various configurations other than those in the above-mentioned example embodiments can also be adopted.

What is claimed is:

1. An information processing apparatus comprising:
a first prediction unit predicting a new location of a sensor node that moves and transmits data under Low Power Wide Area (LPWA) protocol;
a second prediction unit predicting an optimal transmission settings of the sensor node using the predicted new location, the optimal transmission settings being used by the sensor node for subsequent data transmission under the LPWA protocol; and
an output unit outputting the optimal transmission settings.

2. The information processing apparatus of claim 1,
wherein the LPWA protocol under which the sensor node transmits data is Long-Range (LoRa) protocol, and
the transmission settings of the sensor node includes at least one of Spreading Factor, Transmitting Power, Code rate, and bandwidth.

3. The information processing apparatus of claim 1,
wherein the second prediction unit predicts the optimal transmission settings of the sensor node so that signal quality of LPWA communication between the sensor node and a gateway apparatus becomes higher than a pre-determined threshold when the sensor node transmits data under the predicted optimal transmission settings.

4. The information processing apparatus of claim 1, further comprising a third prediction unit and a determination unit,
wherein for each candidate transmission time in a subsequent time interval:
the first prediction unit predicts a location of the sensor node at the candidate transmission time;
the second prediction unit predicts optimal transmission settings of the sensor node at the predicted location; and
the third prediction unit predicts battery consumption of the sensor node for LPWA communication with the gateway apparatus under the predicted optimal transmission settings;
wherein the determination unit determines, as the subsequent transmission time in the subsequent time interval, the candidate transmission time corresponding to least battery consumption among battery consumptions predicted for each candidate transmission time;
wherein the output unit outputs the determined transmission time and the optimal transmission settings predicted for the determined transmission time.

5. A control method performed by a computer, the control method comprising:
predicting a new location of a sensor node that moves and transmits data under Low Power Wide Area (LPWA) protocol;
predicting an optimal transmission settings of the sensor node using the predicted new location, the optimal transmission settings being used by the sensor node for subsequent data transmission under the LPWA protocol; and
outputting the optimal transmission settings.

6. The control method of claim 5,
wherein the LPWA protocol under which the sensor node transmits data is Long-Range (LoRa) protocol, and
the transmission settings of the sensor node includes at least one of Spreading Factor, Transmitting Power, Code rate, and bandwidth.

7. The control method of claim 5, wherein the optimal transmission settings of the sensor node is predicted so that signal quality of LPWA communication between the sensor node and a gateway apparatus becomes higher than a pre-determined threshold when the sensor node transmits data under the predicted optimal transmission settings.

8. The control method of claim 5 further comprises:
for each candidate transmission time in a subsequent time interval:
predicting a location of the sensor node at the candidate transmission time;
predicting optimal transmission settings of the sensor node at the predicted location; and
predicting battery consumption of the sensor node for LPWA communication with the gateway apparatus under the predicted optimal transmission settings;
determining, as the subsequent transmission time in the subsequent time interval, the candidate transmission time corresponding to least battery consumption among battery consumptions predicted for each candidate transmission time;
outputting the determined transmission time and the optimal transmission settings predicted for the determined transmission time.

9. A non-transitory computer readable medium storing a program which, when executed by a processor of a computer, causes the computer to perform operations comprising:
predicting a new location of a sensor node that moves and transmits data under Low Power Wide Area (LPWA) protocol;
predicting an optimal transmission settings of the sensor node using the predicted new location, the optimal transmission settings being used by the sensor node for subsequent data transmission under the LPWA protocol; and
outputting the optimal transmission settings.

10. The non-transitory computer readable medium of claim 9,
wherein the LPWA protocol under which the sensor node transmits data is Long-Range (LoRa) protocol, and
the transmission settings of the sensor node includes at least one of Spreading Factor, Transmitting Power, Code rate, and bandwidth.

11. The non-transitory computer readable medium of claim 9, wherein the optimal transmission settings of the sensor node is predicted so that signal quality of LPWA communication between the sensor node and a gateway apparatus becomes higher than a pre-determined threshold when the sensor node transmits data under the predicted optimal transmission settings.

12. The non-transitory computer readable medium of claim 9, the operations further comprises:
for each candidate transmission time in a subsequent time interval:
predicting a location of the sensor node at the candidate transmission time;
predicting optimal transmission settings of the sensor node at the predicted location; and
predicting battery consumption of the sensor node for LPWA communication with the gateway apparatus under the predicted optimal transmission settings;
determining, as the subsequent transmission time in the subsequent time interval, the candidate transmission time corresponding to least battery consumption among battery consumptions predicted for each candidate transmission time;
outputting the determined transmission time and the optimal transmission settings predicted for the determined transmission time.
